(19) United States
(12) Patent Application Publication
(10) Pub. No.: US 2007/0254275 A1
(43) Pub. Date: Nov. 1, 2007

(54) Training system assembly, and associated methodology, providing for personnel training remote from a training host location

(76) Inventor: Dan Gonos, Folsom, CA (US)

Correspondence Address: SCHEEF & STONE, L.L.P., 5956 SHERRY LANE, SUITE 1400, DALLAS, TX, 75225, US

(21) Appl. No.: 11/415,338

(22) Filed: May 1, 2006

(51) Int. Cl. G09B 3/00

(52) U.S. Cl. 434/350

(57) ABSTRACT

An assembly, and an associated methodology, for providing personnel with training and other instruction. A workstation is configured at a support structure, such as a trailer part of a motor vehicle. The local network, once configured, is transported to a location in proximity to the personnel that are to undergo training. A wireless connection, such as a satellite communication link, is formed between the local network and a centralized training host. Training modules are downloadable, by way of the wireless communication link, to the local network, and personnel receive training through use of the workstations, in conjunction with instructor-led instruction, by way of the workstations of the local network.

The present invention relates generally to a manner by which to provide for training of personnel at a location remote from a central training host location. More particularly, the present invention relates to an assembly, and an associated methodology, by which to create a mobile office instructor-led training facility that permits personnel to be trained pursuant to a production application, or other subject, and to provide for interactive instruction to the personnel undergoing the training. Training is provided best to impart instruction for auditory learners, visual learners and kinesthetic learners. The mobility of the mobile office permits its transport to a location in proximity to the personnel, remote from the central training host location.

### BACKGROUND OF THE INVENTION

Educational instruction to impart knowledge to others is mandated throughout many aspects of modern society. While educational instruction is most commonly associated with school-age children and youths, the need to provide educational instruction continues into, and throughout, the working careers of many.

For many, job functions require technical expertise. The technical expertise required to carry out job functions is not merely a static expertise. That is to say, the technical expertise required to carry out one's work function, once acquired, is not unchanging. Rather, an evolving technical expertise is regularly required in many job functions. And, personnel, to carry out their job functions adequately, are required to acquire new expertise and skills.

The additional expertise required of the personnel can, for instance, be self-acquired by individual study. Self-acquired knowledge, i.e., self-instruction, is, however, regularly an inefficient manner by which to gain new technical expertise. Instead, instructor-led classroom training is generally more likely to permit personnel to acquire the additional technical expertise. Through instructor-led, classroom instruction, the personnel are generally able, more efficiently and quickly to learn materials required to obtain the new technical expertise.

For instance, when employees of a company are required to obtain new technical expertise, the employees are sometimes sent to classroom training facilities to receive the additional instruction. Such formal classes are especially common when the technical expertise is specialized. Sometimes, only a small number of people over a large region, or even countrywide, need to be provided with the additional training. The classroom training is conventionally provided at a centralized location, and the personnel undergoing the training travel to the centrally-located classroom. The personnel receive the additional instruction, and, once completed, the personnel travel back to the work location.

For any of various reasons, however, the ability of personnel to travel large distances to a centralized classroom is not a practical option. Travel costs are sometimes prohibitive. Sometimes, the travel is logistically difficult or the personnel might not be available for the training period together with time required for travel to the centrally-located classroom.

In some scenarios, an equipment or application provider provides a product or service to an end user organization. The provider is sometimes required to come, or otherwise elects to, provide instruction for those who shall be using the provider's product or application. While the provider might elect to have the personnel travel to a central location proximate to the provider's organization, for reasons analogous to those above-mentioned, travel by the personnel to the centralized location might well be impractical. That is to say, travel costs, travel logistics, and personnel availability might all prevent the traveling of the personnel to the centralized location.

While personnel might be unable to travel to the centralized location, the need for the personnel to be provided with instruction by which to obtain the additional technical expertise needed best to make use of, or work with, the provider's product or application remains.

The provider might, instead, travel to the location at which the personnel that are to receive the instruction work or reside and provide the instruction locally, i.e., remote from the centralized location. While possible, a problem results if equipment and instructional aids needed for the instruction is unavailable remote from the centralized location.

There is a continuing need, therefore, to provide for instruction of personnel that are positioned remote from a centralized location. A manner that would better provide for the remote instruction of the personnel would therefore be advantageous.

It is in light of this background information related to education and training of personnel that the significant improvements of the present invention have evolved.

### SUMMARY OF THE INVENTION

The present invention, accordingly, advantageously provides an assembly, and an associated methodology, by which to provide for training of personnel at a location remote from a training host location.

Through operation of an embodiment of the present invention, a manner is provided by which to create a mobile-office, instructor-led training facility. The facility permits personnel to be trained pursuant to a production application, or other subject, and to provide interactive instruction to the personnel undergoing the training.

In one aspect of the present invention, a local network is formed, comprised of a plurality of workstations suitably connected together in a networked arrangement. The workstations are of a number, e.g., to permit each of the personnel undergoing training to work at, and in conjunction with, a workstation. The workstations are configured together in the networked connection and connected, in conventional manner, with a local server that operates in conventional manner, e.g., to support office functions, application components, and other functions and applications available for use in conjunction with training of personnel positioned at the workstations of the local network. Additional local-network apparatus, such as computer printer devices and other apparatus available for use by personnel operating the workstations of the local networks form part of the local network.

In another aspect of the present invention, a mobile support facility is provided at which the workstations of the local network are positioned. The mobile support facility forms, e.g., a trailer portion of a vehicle or is otherwise permitting of its transportation, together with the local network. The local network, when positioned at the mobile support facility, is permitting of its transportation to a remote location, thereby to transport the classroom formed of the local workstations configured together in the networked connection to a location remote from a training host location and into a location convenient for personnel that are to be provided training. Due to the mobile nature of the mobile support facility, the classroom formed of the workstations configured in the network connection are transportable to successive locations remote from the training host location, thereby to be usable at successive locations for training of successive groups of personnel at the successive locations to which the mobile support facility and the local network supported thereat is transported. Search for a location in proximity to the remote location at which the personnel training is to be carried out is obviated as the entire infrastructure of the local network is transported to the remote location, convenient to the personnel that are to be undergoing training thereat. Alternately, the workstations are shipped to a location remote from the training host location and in proximity to the personnel that are to undergo training. Once delivered to the remote location, the workstations are configured in the networked connection, thereby to form the local network, available for use by personnel who undergo training at the remote location. Upon completion of the training by the personnel, the local network is disassembled, and the workstations are shipped onto another location, permitting of reassembly and reuse to train other personnel at another remote location.

In another aspect of the present invention, a wireless communication connection is formed between the local network formed of the workstations connected together in the networked connection and the centrally-positioned training host. The wireless connection provides for communication connectivity between the workstations of the local network, remotely positioned, and the centrally-positioned training host. The wireless connectivity formed of the wireless communication connector comprises, e.g., a satellite communication scheme having a satellite receiver positioned together with the workstations of the local network and an antenna transducer positionable to transduce signal energy of communication signals communicated between the training host location and the remote location at which the workstations are configured in the networked connection. Communication connectivity between the local network and the training host positioned at the training host location is alternately provided in other manners such as, e.g., by way of a terrestrial, wireless communication network, or by way of a wireline communication network. Through the formation of the communication connection, personnel positioned at the workstations of the local network are provided access to training modules, and other modules resident, or otherwise stored, at the training host. When the communication connectivity is provided by a satellite communication network, and the appropriate transceiver elements and antenna transducer elements are positioned with, and connected to, the local network, a communication connection is provided between the local network and the centrally-positioned training host merely through conventional operation of the transceiver and transducer. That is to say, the communication connectivity is provided without need of availability of local communication connections, such as connection to a wireline communication network or to a local, terrestrial cellular communication network. An appropriate line-of-sight (LOS) positioning of the antenna transducer is needed to provide for the formation of the communication connection with a satellite of the satellite communication network. When the antenna transducer, and associated transceiver, are supported at the mobile support facility, such as the trailer portion of a motorized vehicle, the elements required for the training of the personnel, including access to training modules stored at a training host, are self-contained, needing little or no infrastructure or connections at the remote location. Selection of the remote location at which the personnel is trained need not be constrained by the availability of local resources. Instead, the selection of the remote location at which to transport the mobile support facility or otherwise form the local network including the network-connected workstations is made solely on the basis of convenience to the personnel undergoing training.

The mobile support facility is of dimensions permitting both the desired number of workstations, and associated personnel undergoing training, and an instructor to be positioned at the mobile support facility. The instructor is able to provide instruction in conjunction with the training modules retrieved from the centrally-positioned training host by way of the wireless communication connection.

Training modules downloadable to the workstations of the local network include visual indicia displayable at video displays of the individual workstations and also provide for kinesthetic operations to be performed by the personnel undergoing training. Visual learners, auditory learners, and kinesthetic learners are all able to receive instruction in manners best permitting their instruction and training.

Conventional reliance upon traveling of personnel to a central location is obviated as the mobile support facility is transportable to, or creatable at, a location remote from the central training location.

In these and other aspects, therefore, a training system assembly, and an associated methodology, is provided. The assembly and methodology is permitting of trainee instruction remote from a central training host location. A local network comprises a workstation usable pursuant to the trainee instruction. The workstations of the local network are connected together in a networked connection. A wireless communication connector is configured to form a wireless connection between the central training host location and the local network. Training modules stored at the training host are retrievable by way of the wireless communication connector and usable at the workstations pursuant to the trainee instruction.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram that includes a representation of an embodiment of the present invention.

FIG. 2 illustrates a functional block diagram, similar to that shown in FIG. 1, but here including a representation of an alternate embodiment of the present invention.

FIG. 3 illustrates a method flow diagram listing the method of operation of an embodiment of the present invention.

### DETAILED DESCRIPTION

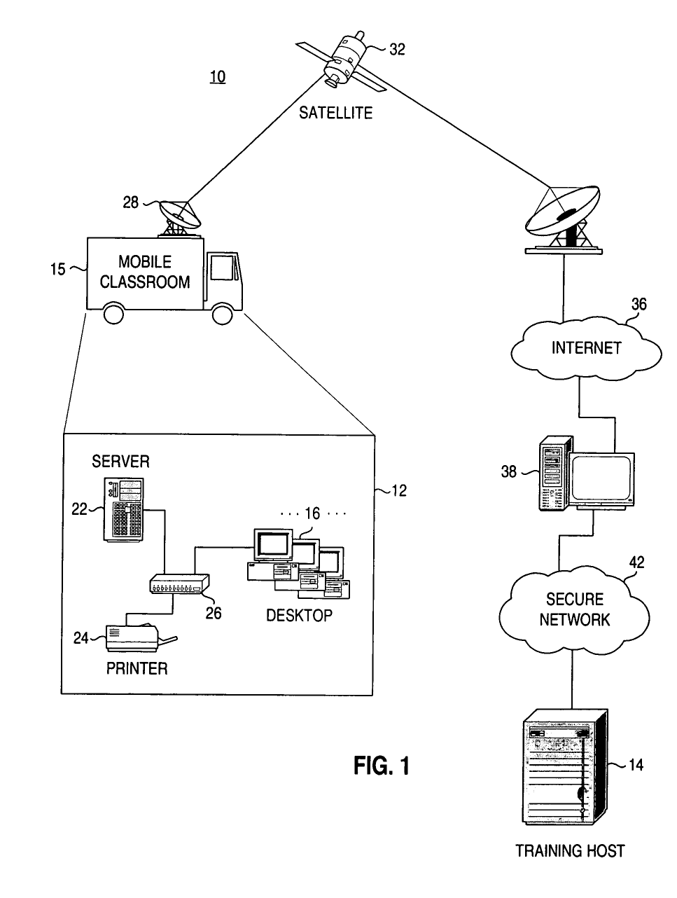

Referring first to FIG. 1, a representation, shown generally at 10, includes an assembly 12 of an embodiment of the present invention. The assembly forms a classroom, positionable remote from a centrally-located training host 14. In the exemplary implementation, personnel that are to receive instruction are provided with the instruction without their traveling to a location in proximity to the training host. Rather, the assembly 12 is transported to a location in proximity to the personnel. Because the personnel need not travel, logistical problems, costs, and other disadvantages associated with a conventional need to transport personnel to a centralized location in proximity to a training host is obviated.

In the exemplary implementation shown in FIG. 1, the assembly 12 is installed at a mobile vehicle, here the trailer portion 15 of a motorized vehicle. The assembly is transported, through operation of the motorized vehicle, to a location in desired proximity to personnel that are to undergo training. The motorized vehicle is subsequently again transportable to additional locations, remote from the centralized training host 14, thereby to permit successive groups, positioned at successive locations, to receive the training and other instruction.

The mobile support facility supports a group of computer workstations 16 configured together in networked connections to form a local network. The computer workstations include video displays, such as those provided by CRT (cathode ray tube) display devices, or the like. When connected together in the networked connections therebetween, the workstations 16 are configured as a local network, which here further includes a local server 22. The local server 22 performs typical server functions, including support of office functions, application components, LAN (local area network) functions, such as DCHP domain controller operations, software distribution, etc.

The local network further includes a printer 24 whose operation is also controlled by operation of the local server 22. A router/hub/switch 26 is further shown in the figure, configurable in conventional manner to provide for the local network connections between the various elements of the local network.

The assembly 12 further includes a wireless communication connector, here represented by the element 28 here shown to be mounted upon the trailer 15. The wireless communication connector here provides for a satellite link connection with the training host 14. The element 28 is representative both of an antenna transducer and of a radio transceiver. The radio transceiver of the element 28 is connected to the local network supported at the mobile support platform. And, when the antenna transducer is properly positioned in a line-of-sight arrangement with a satellite, here represented by the satellite 32, of the satellite communication network, the element 28 provides communication connectivity between the workstations 16 of the local network and the training host 14 by way of a satellite communication connection.

Here, the satellite communication network further includes a corresponding element 34 connected to a network 36, here the Internet. The Internet provides for connection to the training host 14 by way of a firewall 38 and a secure network 42 positioned behind the firewall. When the antenna transducers of the elements 28 and 34 are properly directed, communication signals generated at the radio transceivers of the respective elements are communicated therebetween. And, the workstations positioned at the support structure of the assembly 12 are able to retrieve modules stored at, and to execute functions retrieved from, the central training host 14. The modules and functions are retrieved by way of the wireless communication connection formed by way of the satellite, wireless communication network in a secure manner.

When the assembly 12 is transported to a desired, remote location, a communication connection is formed with a training host 14. Because the assembly is already configured and in position, the workstations 16 are ready for their use by personnel to undergo training and education. Training modules are downloaded to the workstations by way of the wireless communication network, and the training modules are used pursuant to training of the personnel at the workstations. A live instructor is able also to provide instruction to the personnel in conjunction with, or in addition to, the training modules used at the individual ones of the workstations.

The training modules include visual indicia displayable upon the video displays of the workstations, advantageously utilized by personnel who are visual learners. Kinesthetic modules are usable by personnel who are kinesthetic learners, and auditory instruction provided by the training modules and also by the instructor, provides training to personnel who are auditory learners. The advantages of the education provided by way of the training modules resident at the training host are provided without requiring that the personnel travel to a location central to the central training host. Instead, the mobility provided to the assembly 12 and the communication connectivity provided by the communication connector permits the assembly to be transported into proximity with the personnel that are to undergo training.

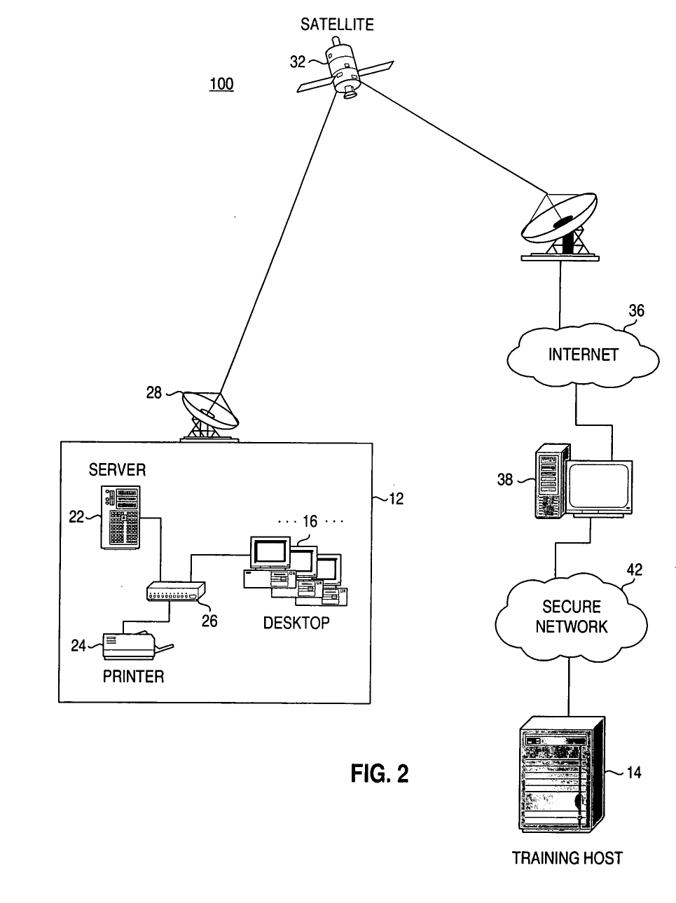

FIG. 2 illustrates a representation, shown generally at 100, of an alternate embodiment of the present invention by which to provide personnel with training remote from a centralized training host 14. Elements of the representation 100 shown in FIG. 2 that correspond to elements described with respect to the representation 10 shown in FIG. 1 are commonly-designated.

The representation shown in FIG. 2 also shows an assembly 12 at which a local network formed of computer workstations 16, a server 22, a printer 24, and a router/hub/switch 26 are supported. An element 28 representative of a satellite radio transceiver and an antenna transducer is also formed at the assembly 12.

In this implementation, the assembly 12 is land-based. That is to say, the assembly, rather than being formed at a trailer portion of a motorized vehicle, is assembled at a land-based facility. For instance, a facility such as a university location is identified, and the equipment forming the elements of the assembly 12 is shipped to the facility. Once delivered to the facility, the local area network is brought on-line, and a satellite link is established for connectivity to the training host 14 by way of the satellite communication link and the data network including the Internet 36 and private network 42.

Personnel that are to undergo training travel to the facility at which the assembly 12 is assembled. The personnel are positioned at individual ones of the workstations 16 and are provided with access to training modules downloadable from the training host to the individual ones of the workstations. An instructor overseeing the training at the assembly 12 also provides traditional, stand-up lectures and presents local visual aids, such as flip charts or other local displays. The training modules also provide visual indicia displayable upon individual ones of the workstations and, also, e.g., displayable upon a common screen, such as through use of screen projection equipment that provides for a presentation projection. Thereby, a module presentation is reinforced by an instructor-led walkthrough of the subsystems, application, or other subject matter being referenced in the module. Personnel undergoing training, e.g., follow along with the instructor, interacting with the workstations at which they are positioned, thereby to navigate through the system and to access on-line module content by way of an on-line learning management system. Additional reinforcement activities are also provided, such as group discussions, paired activities, question and answer periods, and learning games. Training materials are further provided to personnel undergoing training. The training materials are used in conjunction with modules that pertain, e.g., to a training release of a production application located on the training host 14 and pursuant to which the training is provided.

Through the combination of training modules downloadable to the workstations that are interactive together with instructor-led instruction, personnel are provided with training to facilitate their learning of new subjects, such as production applications with which the personnel are subsequently to work and for which the personnel require proficiency.

For many aspects of training related to mission-critical systems, the availability of an instructor is beneficial. Instructor-led training is particularly important when personnel are required, upon completion of the course of their training, to obtain at least a specified proficiency level. Through use of the assembly, training is delivered with equipment and resources that closely match the operational environment of the end user. Target groups of end users are led through a series of training modules contained in a training course associated with the new application or system. Each training course is made available, e.g., for up to twenty personnel per classroom.

Module content presents curricula that are designed specifically for an end-user group for which support is intended. In the exemplary implementation, each module includes an introduction and an overview presentation using a balanced combination of traditional stand-up lectures provided by an instructor and visual aids, e.g., flip charts, on-line presentation material displayed by way of a learning management system, and presentation projections using screen projection equipment. The module presentation is reinforced, e.g., by an instructor-led walkthrough of subsystems being referenced in the module. Personnel undergoing training follow along with the instruction provided by the instructor using the workstations at which the personnel are positioned to navigate through the system and to access on-line module content by way of an on-line learning management system. Additional reinforcement activities are used, such as group discussion, paired activities, questions and answers, and learning games.

Personnel undergoing training are given an opportunity to utilize user activity guides (UAGs) that contain a series of hands-on exercises that are designed specifically to provide the personnel with an opportunity to practice key concepts and activities presented in the module. The hands-on activities are performed in a system training region better to permit the personnel an opportunity to practice their skills in a simulated environment. Hands-on exercises for each training module are also included in the course, and particular attention is given to enabling the personnel to find instructions for completing specific activities, or job tasks, through the use of performance support tools, e.g., on-line users' manuals, on-line help and quick reference guides, etc. Additionally, the user activity guides include expected outcomes of each scenario so that the personnel undergoing training are informed whether or not the exercises are successfully completed.

Training provided pursuant to operation of an embodiment of the present invention supports adult learning theory. The personnel undergoing training are provided with an opportunity to learn the subject matter in the manner in which each individual prefers to learn. That is to say, auditory learners, those who learn best by listening, are supported through the use of lecture and instructor-led presentation of module content. Visual learners, those who learn best by seeing, are supported through the use of visual aids and graphical presentations of key concepts. And, kinesthetic learners, those who learn best by doing, are supported through the use of hands-on exercises and on-line access to system training regions and performance support tools.

Adult learning theory is further supported by providing the personnel with the opportunity to complete exercises and review module content in a self-paced and self-directed environment. And, through the availability of the instructor, instructor guidance pursuant to the learning process is provided while permitting the personnel undergoing training to be provided learning that is problem-centered, personalized, and self-directed.

Because the instruction need not be undertaken only at a centralized location in proximity to a training host, the training is provided at a location convenient to the personnel undergoing training. Logistics problems and travel costs required of the personnel to travel to the centralized location is thereby obviated.

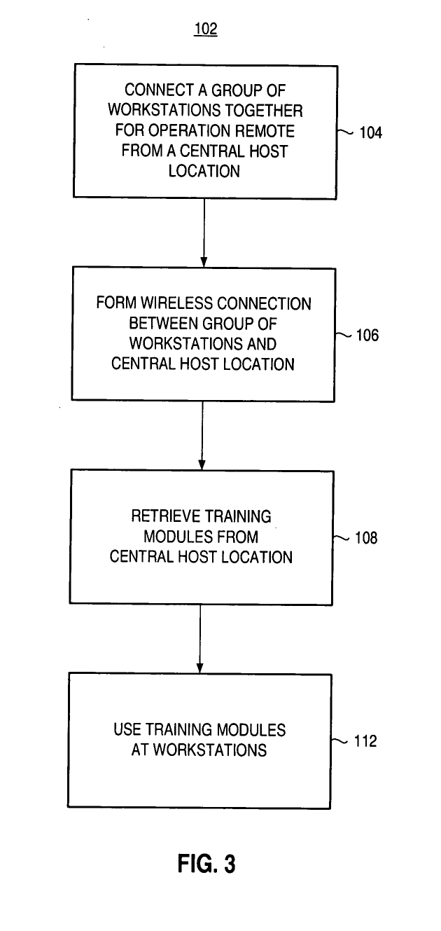

FIG. 3 illustrates a method flow diagram, shown generally at 102, representative of the method of operation of an embodiment of the present invention. The method permits trainee instruction remote from a central training host location and from which the production application is obtained.

First, and as indicated by the block 104, a group of workstations is connected together at a location remote from the central training host location. The group of workstations together forms a local network. Then, and as indicated by the block 106, a wireless communication connection is formed between the local network and the central training host location.

Thereafter, and as indicated by the block 108, training modules stored at the central training host location are retrieved by way of the wireless connection. And, as indicated by the block 112, the training modules are used at the workstations pursuant to the trainee instruction.

Thereby, a manner is provided by which to provide training of personnel remote from a central training host location.

The previous descriptions are of preferred examples for implementing the invention, and the scope of the invention should not necessarily be limited by this description. The scope of the present invention is defined by the following claims.

What is claimed is:

1. A training system assembly permitting of trainee instruction remote from a central training host location, said training system assembly comprising:
a local network comprising workstation usable pursuant to the trainee instruction, the workstations of said local network connected together in a networked connection; and
a wireless communication connector configured to form a wireless connection between the central training host location and said local network, training modules stored at the training host retrievable by way of said wireless communication connector and usable at the workstations pursuant to the trainee instruction.

2. The training system assembly of claim 1 further comprising a mobile physical support facility configured to house the workstations of said local network.

3. The training system assembly of claim 2 wherein said mobile physical support facility is further configured to support part of said wireless communication connector.

4. The training system assembly of claim 3 wherein the part of said wireless communication connector supported by said mobile physical support facility comprises an antenna transducer.

5. The training system assembly of claim 1 wherein said wireless communication connector comprises a satellite communication connector providing for a satellite radio air interface extending between said local network and the central training host location.

6. The training system assembly of claim 1 wherein said wireless communication connector is configured further to provide for communications by the workstations of said local network to the central training host location.

7. The training system assembly of claim 1 wherein said local network further comprises a local network server, the local network server connected in the networked connection with the workstations.

8. The training system assembly of claim 1 wherein said training modules retrievable by way of said wireless communication connector comprise, in part, visual aids displayable at the workstations of said local network.

9. The training system assembly of claim 1 wherein said training modules retrievable by way of said wireless communication connector are usable at the workstations of said local network in conjunction with instructor-led material presentation.

10. The training system assembly of claim 1 wherein said training modules retrievable by way of said wireless communication connector and usable at the workstations of said local network comprise, in part, kinesthetic exercises.

11. The training system assembly of claim 1 wherein the training modules retrievable by way of said wireless communication connector comprise a training release of a production application pursuant to which the trainee instruction is associated.

12. A training method for permitting trainee instruction remote from a central training host location, said training method comprising the operations of:
connecting together a group of workstations at a location remote from the central training host location, the group of workstations together forming a local network;
forming a wireless communication connection between the local network and the central training host location;
retrieving training modules stored at the central training host location by way of the wireless connection; and
using the training modules at the workstations pursuant to the trainee instruction.

13. The training method of claim 12 wherein the group of workstations connected together during said operation of connecting together are supported at a mobile physical support facility.

14. The training method of claim 13 further comprising the operation of moving the mobile physical support facility to a desired training location remote from the central training host location.

15. The method of claim 13 further comprising the operation of supporting part of a communication connector used to form the wireless communication connection during said operation of forming the wireless connection at the mobile physical support facility.

16. The method of claim 12 wherein said operation of forming the wireless communication connection comprises forming a satellite communication link.

17. The method of claim 12 wherein said operation of retrieving comprises requesting retrieval of the training modules.

18. The method of claim 17 further comprising the operation of displaying visual indicia of the training modules at the workstations.

19. The method of claim 18 wherein the training modules retrieved during said operation of retrieving comprises kinesthetic exercises.

20. The method of claim 18 wherein the training modules retrieved during said operation of retrieving are usable at the workstations of the local network in conjunction with an instructor-led material presentation.
